(19) United States
(12) Patent Application Publication
(10) Pub. No.: US 2022/0156681 A1
(43) Pub. Date: May 19, 2022

(54) AERIAL DELIVERY LOCATION IDENTIFIER

(71) Applicant: DROPZONE.STORE LLC, Spring Hill, FL (US)

(72) Inventor: Marvin Hill, Spring Hill, FL (US)

(21) Appl. No.: 17/524,446

(22) Filed: Nov. 11, 2021

Related U.S. Application Data
(60) Provisional application No. 63/113,296, filed on Nov. 13, 2020.

(51) Int. Cl. G06Q 10/08; B64C 39/02; G06F 21/60; G06K 19/06

(52) U.S. Cl. CPC G06Q 10/083; B64C 39/024; B64C 2201/128; G06K 19/06018; B64C 2201/027; G06F 21/602

(57) ABSTRACT

The present disclosure relates to systems and methods to an aerial delivery location identifier including a sheet having a main body defining a peripheral edge, the main body defining a first side and a second side. The sheet is positioned at least partially above a support surface with at least a portion of the second side facing the support surface and at least a portion of the first side facing away from the support surface. Identifying information is positioned on the first side and at least a portion of the first side is illuminated by a light source positioned on or adjacent the main body.

### CROSS-REFERENCE TO RELATED APPLICATIONS

This application claims the benefit of priority pursuant to 35 U.S.C. § 119(e) of U.S. provisional patent Application No. 63/113,296, filed Nov. 13, 2020, entitled “Aerial Delivery Location Identifier,” which is hereby incorporated by reference herein in its entirety.

### BACKGROUND

The delivery of items to an intended delivery location, such as a physical street address, has typically been performed by automobile, truck, bicycle courier or other traditional means. Relatively recently, aerial delivery vehicles are also being used for these deliveries. Aerial delivery vehicles can deliver packages effectively, and sometimes may improve delivery times by avoiding delays often impacting delivery by other means, including traffic issues. Delivery by aerial vehicle requires the item to be deposited at the intended delivery location 128. While transporting an item to the intended delivery location may be highly accurate given the common use of geo-based and other well-known information, the location of precisely where at the intended delivery location the item should be deposited may be difficult for an aerial vehicle to determine.

It is therefore desirable to provide an apparatus by which an aerial delivery vehicle may determine where at the intended delivery location to deposit its payload.

### SUMMARY

To enhance the success of aerial delivery to an intended delivery location, an aerial delivery location identifier is disclosed below as described in this specification and defined by the claims.

In one example, optionally a drone delivery location identifier includes at least one sheet having a main body defining a peripheral edge, the main body defining a first side and a second side, the sheet positioned at least partially above a support surface with at least a portion of the second side facing the support surface and at least a portion of the first side facing away from the support surface, and including identifying information positioned on the first side; and at least a portion of the identifying information being illuminated by a light source positioned on or integral with the main body. Additionally, the identifying information includes at least one of geo-location coordinate, physical address, name, symbol, and barcode. Additionally or alternatively, the identifying information includes encrypted code.

In another example, optionally, any of the drone delivery location identifier as described above wherein the at least one light source is positioned at or near the peripheral edge. Additionally, the at least one light source includes a stake having one end penetrate the support surface to secure sheet to the support surface. Additionally or alternatively, the sheet includes a grommet positioned at or near a peripheral edge, the grommet forming an aperture, and the one of the at least one stake positioned through the aperture to penetrate the ground and secure the sheet to the support structure. Alternatively or additionally, the at least one light source includes a light emitter positioned at an end of the stake opposite the one end. Alternatively or additionally, the light source is a length of rope lights positioned adjacent at least a portion of the peripheral edge of the sheet. Additionally or alternatively, the light source is black light fluorescent media. Additionally or alternatively, the light source is phosphorescent media. Additionally or alternatively, the light source is reflective media. Additionally, for any of the drone delivery location identifiers as recited above, the light source is powered by any one or more of solar energy, battery power, line-power, and UV light incident on sheet.

In another example, optionally, at least one of the drone delivery location identifiers as described above wherein the sheet is rigid. Alternatively, the sheet is flexible.

In another example, optionally, at least one of the drone delivery location identifier as described above the main body is movably secured to the support surface by a securing device. Additionally or alternatively, the securing device is at least one stake. Additionally or alternatively, the at least one stake is positioned adjacent the peripheral edge. Additionally or alternatively, the at least one stake includes more than one stake positioned at discrete locations around the peripheral edge. Additionally or alternatively, the securing device is continuous or discontinuous peripheral weighting. Additionally or alternatively, the securing device is at least one discrete weight container connected with the sheet. Additionally or alternatively, the securing device suspends the sheet above support surface. Additionally or alternatively, the securing device engages a structure floating on liquid support surface. Additionally or alternatively, the securing device is a heat activated adhesive for attachment of the sheet to a support surface permanently.

In another example, optionally, at least one of the drone delivery location identifier as described above a plurality of sheets arranged on the support surface to form a single delivery location identifier. Additionally or alternatively, a plurality of sheets are arranged on the support surface at the intended delivery location in a spaced apart manner to facilitate the delivery of more than one package concurrently by a plurality of aerial delivery vehicles.

### BRIEF DESCRIPTION OF THE SEVERAL VIEWS OF THE DRAWINGS

FIG. 1A shows an example of an aerial view of a residential lot with the aerial vehicle delivery location identifier visible.

FIG. 1B shows an example of an aerial vehicle above a support surface with a delivery supporting a vehicle location identifier, the identifier having information and light sources.

FIG. 2 shows a top view of the aerial delivery location identifier positioned above a support surface.

FIG. 3a shows one example of a light source for at least partially illuminating the information on the aerial delivery location identifier.

FIG. 3b shows another example of a light source for at least partially illuminating the information on the aerial delivery location identifier.

FIG. 3c shows another example of a light source for at least partially illuminating the information on the aerial delivery location identifier.

FIG. 3d shows another example of a light source for at least partially illuminating the information on the aerial delivery location identifier.

FIG. 4a shows an example of a securing device for an aerial delivery location identifier.

FIG. 4b shows an example of a securing device for an aerial delivery location identifier.

FIG. 4c shows an example of a securing device for an aerial delivery location identifier.

FIG. 5a shows an example of an arrangement of a plurality of aerial delivery location identifiers.

FIG. 5b shows another example of an arrangement of a plurality of aerial delivery location identifiers.

### DETAILED DESCRIPTION

The present disclosure relates to an aerial vehicle delivery location identifier 100. In one example, the present disclosure relates to the delivery location identifier 100 positioned at a precise spot at the intended delivery location 128 that an item 102 is to be deposited to complete the delivery. The delivery location identifier 100 provides a specific location for the aerial delivery vehicle to deposit its payload, such as an item ordered for delivery from an on-line marketplace, and also may include information 120 corresponding to the location at which the sheet 108 is positioned. The information may be useful for the delivery vehicle 104 in identifying the desired specific place to deposit the payload 102, and may be helpful to confirm the completion of the payload delivery. The delivery location identifier 100 may be positioned in a particular precise spot at the intended delivery location 128 for many reasons, such as including to provide convenient access by the intended recipient, to provide clear access from the sky to avoid interfering with the flight of the aerial vehicle, and/or to position the payload in a location that is more secure to help reduce the chance of package theft after delivery. The delivery location identifier 100 also concentrates the location of the delivery of more than one payload intended delivery location 128 so that the delivered payloads 102 are not spread around at different locations at the intended delivery location 128.

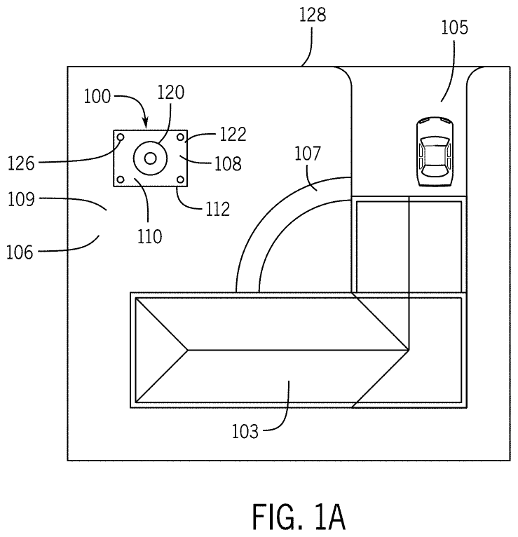

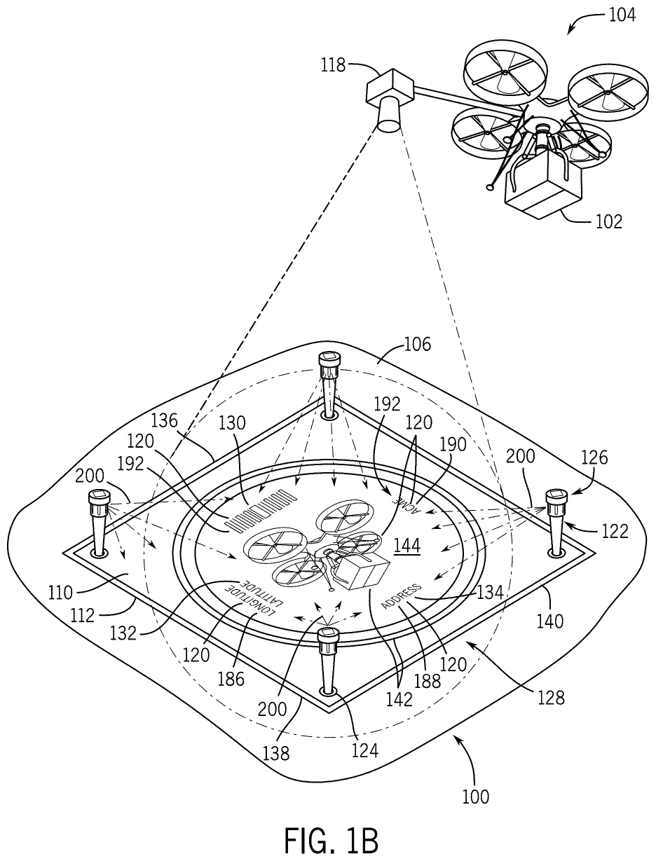

FIG. 1a is a general example of the use of the delivery location identifier 100, and is a Birdseye view similar to that of an aerial delivery vehicle 104 of the intended delivery location 128 prior to delivering the payload 102. The intended delivery location 128 in this example is a physical address of a residential real estate lot, with the area of the lot being covered by a variety of features, including a residence structure 103, a concrete driveway 105, a concrete sidewalk 107 extending from the driveway 105 to the residence, and a yard 109 making up the balance of the lot area. In order to direct the aerial delivery vehicle to deposit the payload 102 in the location desired by the intended recipient of the payload, the delivery location identifier 100 is positioned in the yard 109. The aerial delivery vehicle views the intended delivery location 128 and identifies the delivery location identifier 100. The delivery location identifier indicates to the aerial delivery vehicle that the payload 102 should be deposited on the delivery location identifier. The delivery location identifier 100 may include in this example a sheet 108 having a main body 110 and peripheral edges 112. The sheet 108 may be secured to the support surface 106 (yard 109 in this example) by securing devices 122 (also may be referred to as retaining devices). Light sources 126 may be associated with the sheet 108 to illuminate the sheet 108 for delivery in low light. Information 120 may be positioned on the sheet for the aerial vehicle to sense for a variety of purposes, such as for example, confirming the delivery location identifier 100 matches the intended delivery location 128, or locating the target upon which the payload is to be deposited, or for obtaining information that confirms that a delivery has been made, or any combination of the above. The delivery location identifier 100, in alternative examples of FIG. 1a, may be positioned at least partially on the roof top of the residence, or at least partially on the driveway, or at a different location in the yard. Alternatively, the delivery location identifier 100 may be positioned at a location different than the intended delivery location 128 in this example the residential lot), such as for example the neighbor's residential lot. This might be the case where the intended delivery location 128 does not have any place on the lot for safe delivery by an aerial delivery vehicle, so the intended recipient may place the deliver location indicator 100 on the next door neighbor's residential lot instead.

Referring to FIG. 1b, an aerial delivery vehicle 104 is shown carrying a payload 102 for delivery to an intended delivery location 128. The aerial vehicle may include typical navigational technology to allow it to fly to and locate the intended delivery location 128 (such as, for instance, a street address), and may include a camera 118 or other visual sensors or equipment, along with onboard processing and communication capabilities, to allow the aerial vehicle to survey the delivery location 128 to determine an acceptable precise spot at the intended delivery location 128 to deposit the payload 102. Where the delivery location identifier 100 is positioned on or above a support surface 106, such as the ground, at the delivery location, the aerial vehicle 104 may visually detect the identifier 100 and align itself to deposit the payload 102 on the identifier 100. The aerial delivery vehicle 104 may include a drone, a helicopter, or a robotic helicopter, or other aerial delivery vehicles capable of delivering payload to a particular intended delivery location 128. The aerial delivery vehicle may navigate by pre-programmed instructions, remote control or partially or fully autonomous (with or without operator intervention). Exyn Technologies, Aero Systems West, Skydio, DJI, RMUS and others may offer aerial delivery vehicles suitable for such delivery purposes. In the disclosure herein, an example of a drone, referred to with the same reference number 104 as the generic aerial delivery vehicle, is used for consistency and clarity. The payload being delivered may include many different types of objects that are able to be carried by an aerial vehicle, such as consumer goods, food, medicine or medical products, industrial products, manufacturing components, commercial goods, or the like. In the disclosure herein, an example of the payload is a package containing consumer goods.

The delivery location identifier 100 may in some examples be a sheet 108 of a material defining a main body 110 and defining a peripheral edge 112, where the main body includes a first side 114 and a second side 116. The first side is arranged to be directed upwardly so as to be at least partially viewable by the camera 118 on the drone. The first side may include information 120 helpful to the drone 104. The second side 116, in this example opposing the first side, is facing the support surface 106. The peripheral edge 112 of the sheet 108 may define the shape of the sheet. In the example shown in FIG. 1, the sheet 108 is rectangular in shape and has four linear edges or sides 136, 138, 140, and 142. The sheet 108 may be removably secured in location above the support surface 106 so that it does not unintentionally move once it is positioned on the support surface. For instance, securing devices 122, for example stakes, may be positioned through grommets 124 located near the periphery 112 of the sheet, with the securing devices 122 pushed into the support surface (for example where the support surface is the ground). The sheet may be illuminated by light sources 126 positioned near or integrated with the sheet, such as mounted at the top of the securing devices 122. The light sources 126 illuminate the information 120 on the sheet to make it easier for the drone to locate the sheet and visually scan the information 120 on the first surface 114.

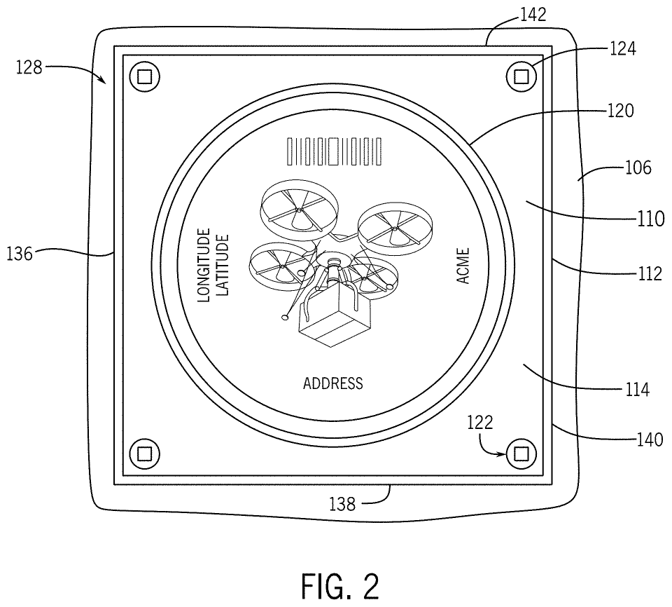

Referring to FIGS. 1 and 2, information 120 related to the intended delivery location 128 may be located on the sheet 108. The drone 104 may use the information 120 to confirm that the intended delivery location 128 is in fact the proper delivery location. The information may be located on the sheet 108 at a variety of positions and orientations. For example, the information 120 may be positioned on the first side 114 of the sheet 108. The information 120 may be printed or otherwise applied to the first side 114 so that it is able to be legible and viewed by the drone 104 prior to depositing the payload 102 on the sheet 108. The information 120 may include the geographic coordinates 186 of the intended delivery location 128, such as latitude and longitude information, or may include the physical street address 188 of the intended delivery location 128, or may include the name 190 of the individual or organization that is intended to receive the package 102. These are examples of information 120 helpful in confirming if the package is being delivered by the drone 104 to the intended delivery location 128. Additionally, a machine-readable code, such as a scannable barcode 192, a 2-D barcode, or matrix code, may be part of the information 120 located on the first side 114 of the sheet 108. The information may be in encrypted form, requiring a key, or other translation process such as software as is known, to be unencrypted by the system on the drone. Machine-readable code, such as for example the scannable barcode 192 (or other forms of machine-readable code) is considered one form of encrypted code. The machine-readable code, such as for example, barcode symbol 192, may incorporate some or all of the above-referenced information, and may include other information as desired by the individual or organization receiving the delivery, or as instructed by the organization making the drone delivery. A symbol or symbols 142 may also be positioned on the first side 114 of the sheet 108 to provide visual information to the drone 104 for purposes of indicating the sheet is the desired location for the package delivery, or for confirming the actual delivery location is the intended delivery location 128, or both. Symbol 142 may be of a variety of things, such as a football helmet, baseball cap, or other sports or non-sports objects.

The information 120 may be positioned on the main body 110 and be centrally located on the first side of the main body of the sheet 108, and/or may be near the peripheral edge 112 as shown in FIGS. 1 & 2. In the example shown in FIGS. 1 and 2, the information 120 may be partitioned into separate sets, such as set 1 130, set 2 132, and set 3 134, with each of the separate sets positioned spaced apart from each other. In one example, set 1 130 is barcode information 192 which is located on the main body 110 and positioned hear a peripheral edge 136. Set 2 132 may be geolocation information 186, such as latitude and longitude, and is positioned along a peripheral edge 138 adjacent to the peripheral edge 136. Set 3 134 may be a physical address 188, which is positioned along a peripheral edge 140 adjacent to peripheral edge 112 and at the opposing side of the square shape sheet 108 from set 1 130. The information 120 may include only one set of information, or may include more than one set of information as described. The information 120 may also include a symbol 142, which may be considered set 4 144, such as the star inside a circle positioned at a central location of the main body 110 as shown in FIG. 1. The symbol 142 positioned in this central location may act as a target for the drone to use in depositing its package 102. The symbol 142 may be any of a variety of one or more shapes and/or images. The name 190 of the individual or organization to receive the package 102, and may be considered set 5 192.

The symbol 142, or any of the sets of information 130, 132, and 136, for instance, may be a contrasting color (e.g. black) to the color of the main body (e.g. white). This contrast may aid the drone in identifying the centrally-located symbol 142 and give it a target on which to deposit the package 102. This helps make sure the package is located centrally on the sheet 108 (in the example of the symbol 142 being centrally located) and keep the package from getting dirty, wet, or otherwise damaged by touching the support surface 106. Additionally, by centrally locating the target drop location on the sheet 108, the information 120 positioned around the periphery 112 of the sheet are not easily blocked from being viewed by the drone for subsequent deliveries of additional packages. The colors of the information 120 may all be the same, or the sets 1, 2, 3, 4 and/or 5 of information 120 may vary in color from one another. The contrast between the information 120 and the sheet 108 may be a high contrast, such as black and white, or may be a more subtle contrast, such as blue and green. The colors of the sheet and the information 120 may be professional or college sports team colors. In this example the information 120 is shown on the first side of the sheet 108, but may also be positioned on the second side of the sheet 108, or both. The information 120 positioned on the first side or second side, or both sides, of the sheet 108 may be the same information or different information. Different information on the first side from the second side would allow the sheet 108 to be used for different purposes. For instance, the first side may have the information 120 corresponding to the recipient's first location (e.g. primary home), and the second side may have the information 120 corresponding to the recipients second location (e.g. vacation home). The sheet 108 may be reversible and used with either the first side or the second side facing upwardly for viewing by an aerial delivery vehicle.

The sheet 108 may be flexible, such as being made of a relatively thin material having pliability, such as a woven or non-woven fabric of natural or man-made materials (such as a thin plastic sheet), or a combination. The sheet 108 may have a single layer or may a laminate of more than one layer to provide more robust resistance to weathering. In the flexible example, the sheet 108 may be 5 mil to 50 mils thick, or more or less. In one example, the sheet material may be LexJet TOUGHcoat Polypropylene Extra at 9 mils thick. In another example, the sheet material may be Neschen Pure Color Media at 16 mils thick. In either case the first side 114 is opposite the second side 116. Alternatively, the sheet 108 may be a plurality of components assembled together. For example, where the sheet 108 is to be applied to a rigid support surface 106, such as concrete or asphalt, the sheet 108 may be a collection of thermoplastic film portions applied using a heating process, for example in a manner similar to 3M Stamark™ pavement marking tape, or thermoplastic hot mark tape from companies such as Start Traffic (https://starttraffic.uk/roadmark-road-line-markings). See also applying a Hotmark/Hotline thermoplastic road markings at https://youtu.be/QOMkZRppx_Y. Alternatively, the sheet 108 may be substantially rigid (such as being made of sheet steel or plywood) or somewhat flexible, such as being made of plastic, thin flexible wood, thin flexible metal, or a combination. In one example, the substantially rigid material may be corrugated plastic sheeting, 4 mils thick, such as by Abatix Approved. In this rigid example, the sheet 108 may be one-eighth inch to five inches thick (or more or less) or a wood or sheet steel

The peripheral edge 112 of the sheet 108 generally determines the shape of the sheet 108. The shape of the sheet 108 may be rectilinear, non-rectilinear or a combination of the two. For instance, the shape may be a geometric shape, such as without limitation a square, rectangle, circle, oval, triangle, or diamond, or it may have a random shape, or it may be a combination of both. The dimensions of the sheet 108, depending on the shape, are sufficient for at least a portion of the information 120 to be read by the camera 118 on the drone 104 from a distance of approximately about 0 feet to 200 feet (or more) above the sheet. For example, where the sheet 108 has a circular shape, the diameter may range between 24 inches and 60 inches, and may be approximately 36 inches or more. In another example, where the sheet is square, the length of each side ranges from 24 inches to 60 inches or more, and may be approximately 36 inches. In one example the information 120, such as lettering on the sheet 108, may be sufficiently sized to be sensed by the camera on the drone from distances in the range of about 0 to 200 feet. For example, and without limitation, in FIG. 2 the information 120, such as the lettering, may have a height of approximately 5 inches, or may be 1.5 inches, or may be 0.5 inches, or may be ⅝ inches. The sizes may be larger or smaller also. The symbol or image on the sheet 108 may be sized in the range of 16 inches by 16 inches, or may be 8 inches by 8 inches, or may be 20 inches by 20 inches. The sizes may be larger or smaller also.

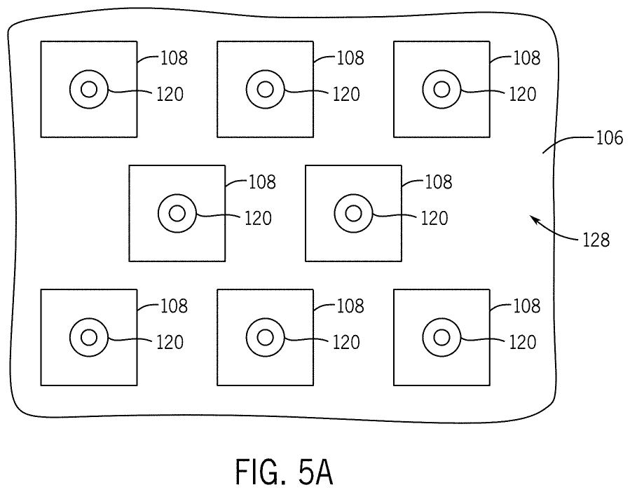

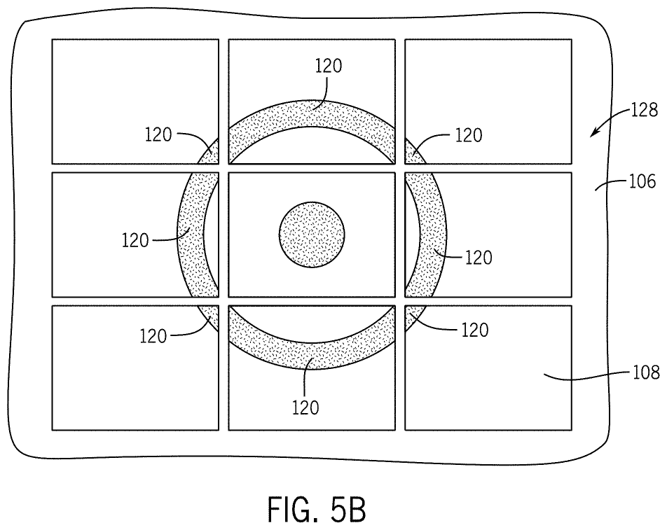

Referring to FIG. 5A, a plurality of sheets 108 may be combined with other sheets 108 into an array or pattern 198, thus covering a larger area of the support surface 106. The plurality of sheets may be spaced apart such as for instance in a checkerboard pattern, and removably secured in place, to provide adequate space for a plurality of drones 104 to deliver their respective packages 102 at or near the same time without interfering with one another. Alternatively, a plurality of sheets 108 may be positioned adjacent one another, including even touching or near touching, to create a single large delivery location identifier 100′. In this instance, the information 120 positioned on each sheet may be arranged so that when laid out together in the desired pattern the information 120 on each sheet combines with the information 120 on adjacent sheets to form a complete depiction of the information 120. See FIG. 5b.

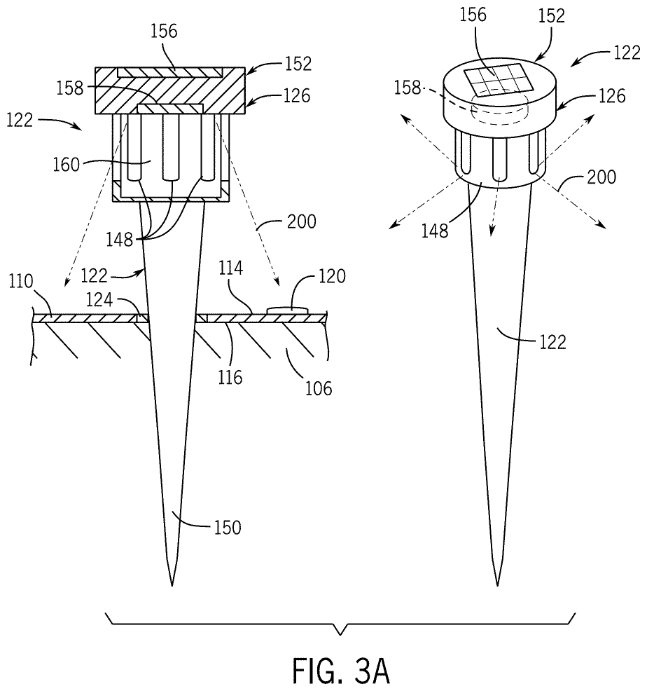

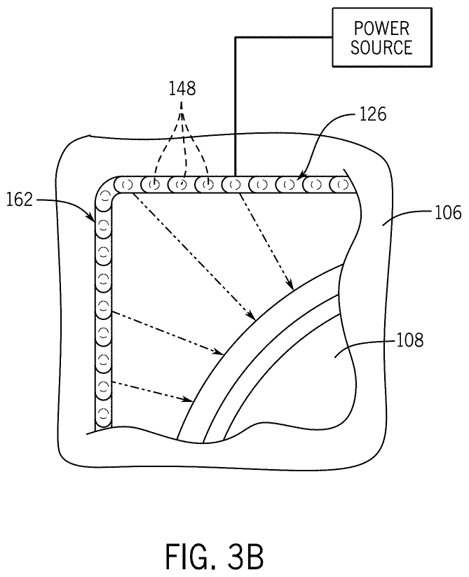

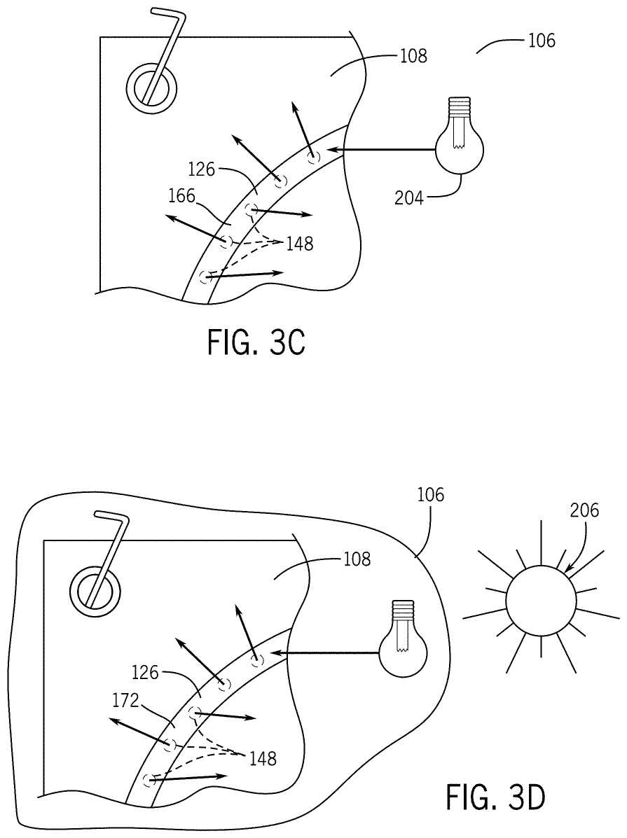

Referring to FIGS. 3A, 3B, 3C, and 3D, the sheet 108 may be illuminated to allow the delivery of packages 102 at times when the natural light level is low, such as in the evening or overnight. The sheet 108 may be illuminated by one or more light sources 126 integrated with the sheet 108 itself, either in the securing device 122 removably securing the sheet 108 to the support surface 106, or by the type of material used to print or otherwise mark or apply at least part of the information 120 on the first side 114 of the sheet. An illuminated sheet 108 would allow delivery of packages 102 at nighttime, help assist the drone 104 to locate the sheet 108 in the dark for accurate deployment of the package. Illumination would reduce the need to search the entire property for the proper delivery location 126, decrease missing packages, and may increase security of the packages once delivered. The light source 126 may be controlled by an ambient light sensor to turn the light source 126 on in low light, such as for use in the evening or overnight, and turn the ds source 126 off once the ambient light is sufficient. The light source 126 may be powered by solar power, battery power, line power or a combination of any one or more. The light source 126 itself may include a light emission element 148 that may be LED, incandescent, fluorescent, halogen, phosphorescent or fluorescent or another type. FIG. 3A shows a securing device 122, for instance a stake portion 150, with a light source 126 in the form of a solar powered light 152 positioned at an upper end. The stake portion 150 is positioned through a grommet 124 located in the sheet 108 (such as for example near a peripheral edge 112 as shown in FIG. 1). A plurality of stake portions 150 may be positioned in the support surface 106, such as the ground, so that the light emission elements 148 are adjacent the support surface (see FIG. 3a), with relatively localized illumination 200 of the information 120. Alternatively, the light emission elements 148 are spaced above the ground (see FIG. 1) which may allow their illumination zone 202 to cast further across the sheet 108 and onto the information 120. The bottom portion of the stake portion 150 is pushed into the support surface 106, and the top end remains above the support surface 106. The solar powered light 152 may include solar panels 156 for converting the sun's energy into electricity, and a battery 158 for storing the electricity for later use. Light emission elements 148 may be powered by the solar panels 156 and/or the battery 158, and/or line voltage and are housed in a chamber 160 with clear or translucent walls that allow the light to escape the chamber 160 and illuminate the surrounding area, including the sheet 108. The stake portions 150 can be removed from the support surface to allow the sheet to be moved and relocated. One such solar powered light 152 is the Gigalumi Solar Path Lights (https://www.amazon.com/GIGALUMI-Outdoor-Landscape-Driveway-Stainless/dp/B07WGBWBTC/ref=sr_1_13?dchild=1&keywords=outdoor+solar+path+light+garden+1andscape&qid=1604461754&sr=8-13).

FIG. 3B shows another type of light source 126. A light rope 162 is attached to at least a portion of the length of the periphery 112 of the sheet 108 or to a portion of the field (central region) of the main body of the sheet 108. The light rope 162 (such as by AQ Lighting, see https://www.aqlightinggroup.com/rope-light/?gclid=EAIaIQobChMIn8j33P7n7AIVUdbACh0Y4wdFEAAYASAAEgLiKPD_BwE) may be powered by solar, battery, or line voltage. The light emission elements 148 within the light rope 162 may be incandescent, LED or other. The light emission elements 148 cast sufficient light on the information 120 for the camera 118 on the drone 204 to visually detect the information 120.

FIG. 3C shows the information 120 applied to the sheet 108 using a black light (e.g. UV light) fluorescent media 166 (for example ink or paint), which is self-illuminating when under black light 168. The light emission elements 148 are within the media. Where a drone 104 includes black light source 204, or where black light (UV) source is otherwise exposed to the sheet 104, the black light fluorescent media 166 forming at least part of the information 120, and specifically the light emission elements 148 within the media, would illuminate and be able to be viewed by the camera 118 on the drone 104.

FIG. 3D shows the information 120 applied to the sheet 108 using a phosphorescent media 172 (such as for instance paint or ink). Phosphorescent media 172 is self-illuminating after being exposed to natural sunlight (and other types of light). The light emission elements 148 are within the media 172. This effect would allow the information 120 positioned on the sheet 108 to be seen in low light until the phosphorescence requires recharging under a man-made or natural light source 206.

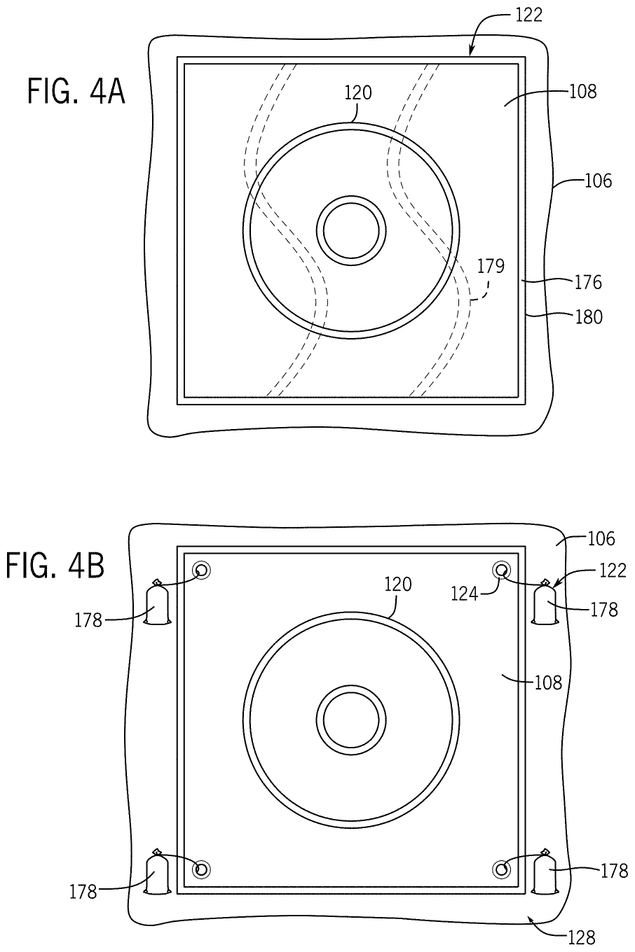

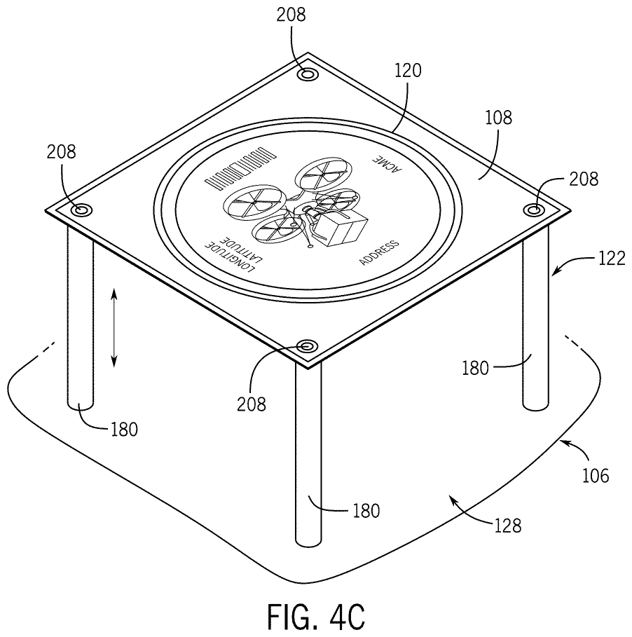

Referring to FIGS. 3a, 4a, 4b, and 4c, the sheet 104 may be secured to the support structure 106 temporarily, allowing the sheet 104 to be relocated as desired by the person or organization receiving the package 102 at the intended delivery location 128 128. FIG. 3a shows the sheet 108 being held by a securing device 122 in the form of at least one stake 150 positioned through grommets 124, in this example positioned adjacent to or at the peripheral edge 112 of the sheet 108. The stakes 50 are pushed into the support surface 106 (for example the ground) to hold the sheet 108 in place. As described above the stakes 150 may have solar powered lights 152 positioned at an upper end to illuminate the sheet 108 when natural light is insufficient. In FIG. 4A, a sheet 108 is shown that includes a securing device 122, such as for example a weighted material 176 attached to the sheet 108 to movably secure it to the underlying support surface 106. In this example, the weight material 176, such as sand or glass beads, are positioned in a hem feature 180 sewn or formed into the peripheral edge 112. The weighted material 176 may alternatively be a chain or other elongated member that is relatively heavy and may be attached along at least a portion of the peripheral edge 112. Alternately, or in addition, the weight material 176 may be positioned within or along the field of the main body of the sheet 108 at least partially between peripheral edges 112, and may extend from one peripheral edge to another as shown by dashed lines. The dashed lines 179 may be pockets formed in the sheet 108 and filled with sand or glass beads (for example only). The dashed lines may alternatively represent weighted material 176 in the form of elongated weighted members attached to the sheet 108 (on either the first side or the second side or both). The pockets may extend from one peripheral edge to another or may not.

FIG. 4B shows the sheet 108 being movably secured in place on the support surface by a securing device 122 in the form of weighted bags 178 attached to grommets 124 by cords, the grommets located in the corners of the sheet 108. FIG. 4C shows the sheet 108 secured to the support surface 106 by a securing device 100 in a manner suspended above the support surface 106. In this example, the sheet 108 is suspended above the support surface by a structure. In this example the structure includes four legs 180, with each leg spaced away from each other, such as being located at each corner of the sheet 108. The sheet 108 may be removably secured to the top of each leg 180 by a fastener 208, removable or permanent, such as a pin, nail, screw, bolt, adhesive or the like. The sheet 108 may also be removably secured to a support platform 184 (for example a sheet of plywood) positioned on the four legs 180. In this example of FIG. 4B the securing device 122 may be the structure suspending the sheet 108 above the support surface, or may be the fastener(s) securing the sheet 108 to the structure, or may the combination of both. One example of a permanent application is where the sheet 108 is thermoplastic applied to the support surface 108 formed of asphalt as noted above. Additionally or alternatively, to secure the sheet 108 to a wooden table top, it may be permanently anchored to the table top by securing the sheet 108 with lag bolts and washers, or bolts, nuts, and washers, or adhesives.

Support surface 106 may be a surface capable of receiving a delivery from a drone, such as the ground, driveway, table, rooftop, object floating on surface of water, or an object suspended off the ground (for example held above ground by posts, etc.). The support surface may be independent of other structures (a constructed platform), or may be integrated into a structure (e.g. a rooftop on a building, or a delivery platform on a ship).

The drone may scan at least some of the information 120, such as the bar code, the physical address, the geo-location information, the name of the intended recipient, and/or the symbol as examples described above, to confirm the it matches with the intended delivery location 128 to confirm that the drone 104 is depositing its package 102 at the correct location. Additionally, the drone may include technology, such as camera 118 or other sensor with the ability to scan a barcode, or take a picture of the sheet 104, to obtain a confirmation of a completed delivery of a package to the correct intended location. One example of such contactless confirmation technology is provided at https://www.barcodesinc.com/barcodesedge/solutions/contactless-signature-technology/.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A drone delivery location identifier comprising:
at least one sheet having
a main body defining a peripheral edge, the main body defining a first side and a second side,
the sheet positioned at least partially above a support surface with at least a portion of the second side facing the support surface and at least a portion of the first side facing away from the support surface;
identifying information positioned on the first side; and
at least a portion of the identifying information is illuminated by a light source positioned on or integral with the main body.

2. A drone delivery location identifier as recited in claim 1, wherein the identifying information includes at least one of geo-location coordinate, physical address, name, symbol, and barcode.

3. A drone delivery location identifier as recited in claim 1, wherein the identifying information includes encrypted code.

4. A drone delivery location identifier as recited in claim 1, wherein the at least one light source is positioned at or near the peripheral edge.

5. A drone delivery location identifier as recited in claim 4, wherein the at least one light source includes a stake having one end penetrate the support surface to secure sheet to the support surface.

6. A drone delivery location identifier as recited in claim 5, wherein the sheet includes a grommet positioned at or near a peripheral edge, the grommet forming an aperture, and the one of the at least one stake positioned through the aperture to penetrate the support surface and secure the sheet to the support surface.

7. A drone delivery location identifier as recited in claim 4, wherein the at least one light source includes a light emitter positioned at an end of the stake opposite the one end.

8. A drone delivery location identifier as recited in claim 4, wherein the light source is a length of rope lights positioned adjacent at least a portion of the peripheral edge of the sheet.

9. A drone delivery location identifier as recited in claim 4, wherein the light source is black light fluorescent media.

10. A drone delivery location identifier as recited in claim 4, wherein the light source is phosphorescent media.

11. A drone delivery location identifier as recited in claim 4, wherein the light source is reflective media.

12. A drone delivery location identifier as recited in claim 1, wherein the sheet is rigid.

13. A drone delivery location identifier as recited in claim 1, wherein the sheet is flexible.

14. A drone delivery location identifier as recited in any of claim 1, wherein the light source is powered by any one or more of solar energy, battery power, line-power, and UV light incident on sheet.

15. A drone delivery location identifier as recited in any of claim 1, wherein the main body is movably secured to the support surface by a securing device.

16. A drone delivery location identifier as recited in claim 15, wherein the securing device is at least one stake.

17. A drone delivery location identifier as recited in claim 16, wherein the at least one stake is positioned adjacent the peripheral edge.

18. A drone delivery location identifier as recited in claim 15, wherein the securing device is continuous or discontinuous peripheral weighting.

19. A drone delivery location identifier as recited in claim 15, wherein the securing device is a heat activated adhesive to attach the sheet to the support surface.

20. A drone delivery location identifier as recited in claim 1, wherein a plurality of sheets are arranged on the support surface at the intended delivery location in a spaced apart manner to facilitate the delivery of more than one package concurrently by a plurality of aerial delivery vehicles.
